(19) United States
(12) Patent Application Publication
(10) Pub. No.: US 2008/0240682 A1
(43) Pub. Date: Oct. 2, 2008

(54) SOUND PLAYBACK APPARATUS

(76) Inventors: Masaki EGAWA, Ome-she (JP); Kei Kariya, Tachikawa-shi (JP); Takanobu Mukaide, Tachikawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/960,141

(22) Filed: Dec. 19, 2007

(30) Foreign Application Priority Data
Mar. 30, 2007 (JP) 2007-095005

(51) Int. Cl. H04N 5/91

(52) U.S. Cl. 386/96

(57) ABSTRACT

According to one embodiment, a sound playback apparatus includes receiving mechanism for obtaining a sound packet including sound data about outputs of a predetermined number of channels, downmix information receiving mechanism for obtaining downmix coefficient information, control mechanism for determining whether downmix processing is to be performed for the sound packet by using the downmix coefficient information or not, sound processing mechanism for performing downmix processing of the sound packet based on the downmix coefficient information when the control mechanism determines to perform downmix processing for the sound packet, and sound output mechanism for outputting the sound data downmixed by the sound processing mechanism to a speaker connection terminal.

### CROSS-REFERENCE TO RELATED APPLICATIONS

This application is based upon and claims the benefit of priority from Japanese Patent Application No. 2007-095005, filed Mar. 30, 2007, the entire contents of which are incorporated herein by reference.

### BACKGROUND

1. Field

One embodiment of the present invention relates to a sound playback apparatus which outputs sound data contained in contents.

2. Description of the Related Art

Currently, high-density optical disks which record data such as images and sounds have become widely available, notably DVDs. Such optical disks record sound information to obtain sound output which content providers originally intend to provide. Therefore, if sound signals are formed with 5.1 channels for low sound and high sound, playback apparatuses preferably have output circuits and speakers ready for respective channels.

However, actually, many sound playback amplifiers and televisions have output circuits and speakers for 2 channels. Further, even some sound playback amplifiers and televisions ready for 5.1 channels select 2 channels outputs as usage pattern thereof.

In preparation for such situations, optical disks record downmix coefficient information which enables output with 2 channels intended by the content provider, when sound to be originally output with 5.1 channels is output by 2 channels.

Jpn. Pat. Appln. KOKAI Pub. No. 2003-187531 discloses a structure of a high-density optical disk, in which downmix coefficient information is transmitted through a surround control signal, and thereby sound is played back.

Further, Jpn. Pat. Appln. KOKAI Pub. No. 2006-294120 discloses a structure in which playback conditions are selected on the basis of decoding playback information of the output apparatus when content having encoded sound data is played back, and a control signal is transmitted by using a CEC line.

However, in the techniques disclosed in Jpn. Pat. Appln. KOKAI Pub. Nos. 2003-187531 and 2006-294120, sound is changed inside the output apparatus in conformity with the number of channels of the speakers, regardless of the downmix coefficient information. Therefore, there is the problem that the output sound is different from sound using downmix coefficient information, which is originally intended by the content provider.

The object of the invention is to provide sound playback apparatus and method, which enable sound output as close to sound intended by the content provider as possible, when sound data recorded on an optical disk is downmixed.

### BRIEF DESCRIPTION OF THE SEVERAL VIEWS OF THE DRAWINGS

FIG. 1 is a block diagram illustrating a configuration of a sound playback apparatus according to a first embodiment of the invention;

FIG. 2 is a diagram illustrating a configuration of an HDMI of the sound playback apparatus according to the first embodiment;

FIG. 3 is a block diagram illustrating a configuration of a sound playback apparatus according to a second embodiment;

FIG. 4 is a flowchart illustrating an operation example of the sound playback apparatus according to the first embodiment; and

FIG. 5 is a flowchart illustrating another operation example of the sound playback apparatus according to the first embodiment.

### DETAILED DESCRIPTION

Various embodiments according to the invention will be described hereinafter with reference to the accompanying drawings. In general, according to one embodiment of the invention, a sound playback apparatus comprises receiving means for obtaining a sound packet including sound data about outputs of a predetermined number of channels, downmix information receiving means for obtaining downmix coefficient information, control means for determining whether downmix processing is to be performed for the sound packet by using the downmix coefficient information or not, sound processing means for performing downmix processing of the sound packet based on the downmix coefficient information, when the control means determines to perform downmix processing for the sound packet and sound output means for outputting the sound data downmixed by the sound processing means to speakers.

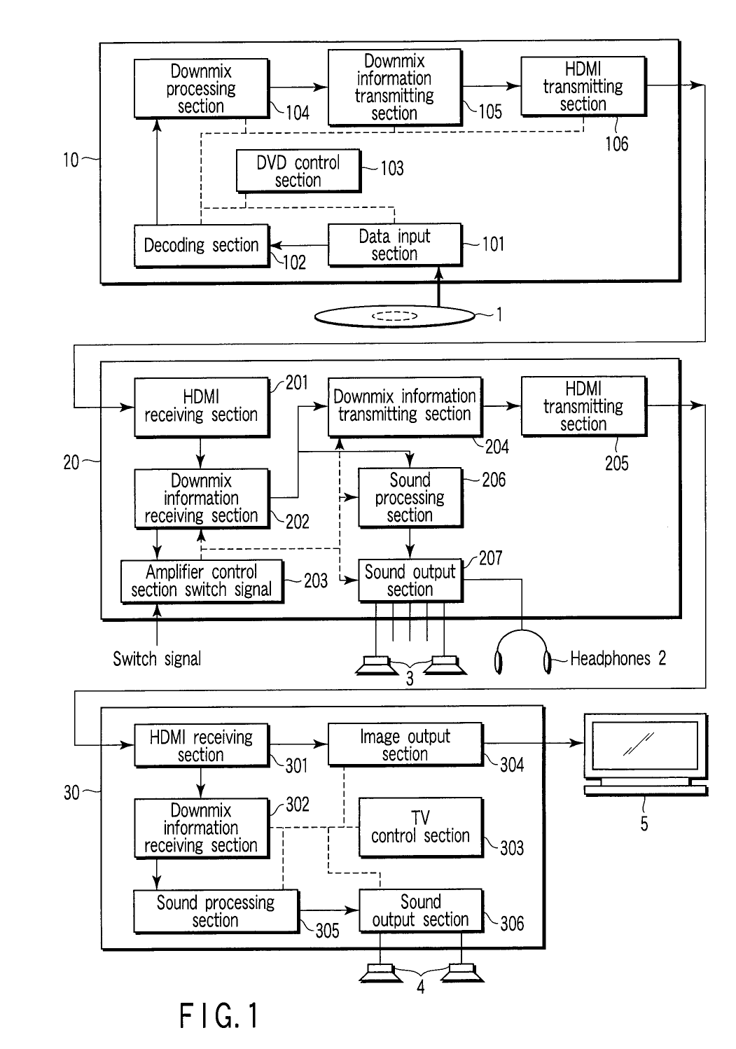

Sound playback apparatuses according to embodiments of the invention are explained below with reference to drawing. FIG. 1 is a block diagram illustrating an example of a system to which a sound playback apparatus of the invention is applied. In this embodiment, explained is an example in which a playback apparatus 10, a relay apparatus 20, and a receiver 30 are connected. The playback apparatus 10, the replay apparatus 20, and the receiver 30 adopt a data transmission system compatible with the High-Definition Multimedia Interface (HDMI) standard, which adopts, for example, HDCP.

In this embodiment, the playback apparatus 10 is a Digital Versatile Disc (DVD) player capable of multi-channel output, the relay apparatus 20 is an AV amplifier capable of multi-channel output, and the receiver 30 is a television only capable of 2-channel output. FIG. 1 illustrates a configuration example in which the playback apparatus 10, the relay apparatus 20, and the receiver 30 are connected in series. Only the playback apparatus 10 and the relay apparatus 20 may be connected directly, or only the playback apparatus 10 and the receiver 30 may be connected directly.

Example of the playback apparatus 10 is a set-top box serving as a DVD player or a digital broadcast tuner. The playback apparatus 10 includes a data input section 101, a decoding section 102, a DVD control section 103, a downmix processing section 104, a downmix information transmitting section 105, and an HDMI transmitting section 106. The DVD control section 103 allows the other sections to execute operation in accordance with instructions by the user. The data input section 101 obtains content information such as images and sound from an optical disk 1 such as a DVD. The decoding section 102 decodes the content information obtained by the data input section 101. The downmix processing section 104 extracts downmix coefficient information, which is designated by the manufacturer (provider) of the content in advance, from a playback signal. Next, the downmix information transmitting section 105 converts the extracted downmix coefficient information into, for example, expanded HDMI packets. The HDMI transmitting section 106 transmits the downmix coefficient information contained in the HDMI packets and packets of image data and sound data of the content decoded by the decoding section 102 to the relay apparatus 20.

A method of transmitting content data and downmix coefficient information by the HDMI transmitting section 106 is explained later in detail.

Examples of the relay apparatus 20 is an AV amplifier used exclusively for sound playback, and an image recording and playback apparatus.

The relay apparatus 20 includes an HDMI receiving section 201, a downmix information receiving section 202, an amplifier control section 203, a downmix information transmitting section 204, an HDMI transmitting section 205, a sound processing section 206, and a sound output section 207.

The HDMI receiving section 201 receives the content data and HDMI packets containing the downmix coefficient information transmitted from the playback apparatus 10. Then, the HDMI receiving section 201 obtains sound packets from the HDMI packets. The sound data contained in the content data is, for example, sound output compatible with 5.1 channels.

The downmix information receiving section 202 extracts the downmix coefficient information from the HDMI packets. The downmix coefficient information is decoded by the amplifier control section 203. Further, the amplifier control section 203 controls the other sections of the relay apparatus 20 in response to switch signals from the outside, and allows the other sections to execute operation.

The user can transmit switch signals to the amplifier control section 203 by using an input unit or a remote controller (not shown), in accordance with whether the output apparatus connected to the relay apparatus 20 is headphones 2 adopting 2 channels output or speakers 3 adopting 5.1 channel surround output. For example, when headphones 2 compatible with 2 channels are connected to the relay apparatus 20, the amplifier control section 203 provides a downmix coefficient for 5.1 channel signal contained in the sound packets to the sound processing section 206, and allows the sound processing section 206 to perform downmix processing to conform the sound to 2 channels output. The amplifier control section 203 may be configured to automatically perform processing of switching to 2 channels output, by detecting that the headphones 2 are connected to the relay apparatus 20. In this case, the sound output section 207 outputs sound conforming to 2 channels output from the headphones 2 connected to the relay apparatus 20.

Further, for example, when the speakers 3 compatible with 5.1 channels are connected to the relay apparatus 20, the amplifier control section 203 does not allow the sound processing section 206 to perform downmix processing. Therefore, the sound output section 207 outputs sound conforming to 5.1 channel output from the speakers 3 connected to the relay apparatus 20, without downmix processing.

As described above, the amplifier control section 203 recognizes identification information or the connection state of the headphones 2 or speakers 3 connected to the sound output section 207, and thereby it is determined whether output is performed with 2 channels or 5.1 channels.

Further, if speakers for only 2 channels are connected to the relay apparatus 20, the user can provide a switch signal to the amplifier control section 203. Then, the amplifier control section 203 provides a downmix coefficient for 5.1 channel signals contained in the sound packets to the sound processing section 206, and allows the sound processing section 206 to perform downmix processing to conform the sound to 2 channels output.

The downmix information transmitting section 204 processes the downmix coefficient information to be contained in HDMI packets. The HDMI transmitting section 205 transmits the downmix coefficient information converted into HDMI packets and content data of image data and sound data of the content to the receiver 30.

Examples of the receiver 30 are a display, a television, and an image recording and playback apparatus. The receiver 30 includes an HDMI receiving section 301, a downmix information receiving section 302, a TV control section 303, an image output section 304, a sound processing section 305, and a sound output section 306.

The HDMI receiving section 301 receives HDMI packets transmitted from the relay apparatus 20 and containing the content data and the downmix coefficient information. Then, the HDMI receiving section 301 obtains sound packets and image packets from the HDMI packets. The downmix information receiving section 302 extracts a downmix coefficient from the HDMI packets. The TV control section 303 controls the other sections of the receiver 30, and allows the sections to execute operations.

Since the receiver 30 in this example is only ready for 2 channels output, the TV control section 303 allows the sound processing section 305 to perform downmix processing based on the sound packets and the downmix coefficient to conform the sound to 2 channels output. Then, the sound output section 306 outputs downmixed sound conforming to 2 channels output from the speakers 4 connected to the receiver 30. The image output section 304 decodes image signals from the image packets obtained by the HDMI receiving section 301, and performs output processing of the image signals for a display 5 such as a monitor.

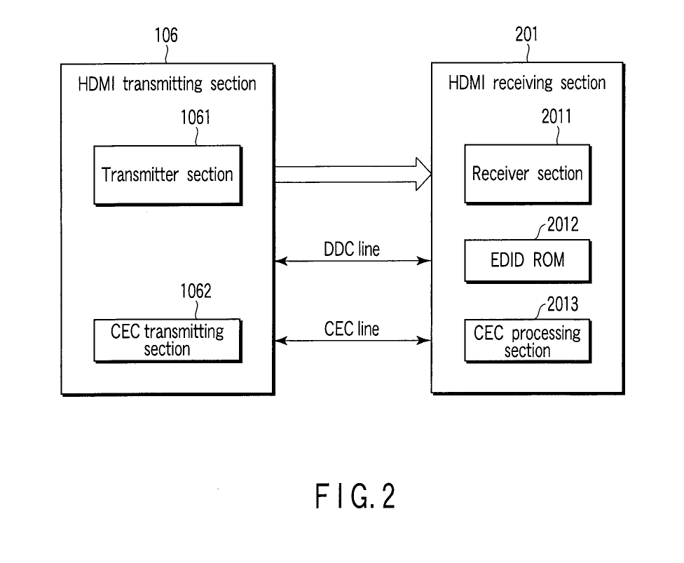

Next, a method of transmitting content data and downmix coefficient information from the HDMI transmitting section 106 to the HDMI receiving section 201 is explained with reference to FIG. 2.

FIG. 2 illustrates information transmission and reception between the HDMI transmitting section 106 of the playback apparatus 10 and the HDMI receiving section 201 of the relay apparatus 20. An HDMI is formed of the part ranging from the HDMI transmitting section 106 to the HDMI receiving section 201. The HDMI transmitting section 106 and the HDMI receiving section 201 are connected by an HDMI cable. A transmitter section 1061 transmits sound data and image data as HDMI packets to a receiver section 2011. Further, a DDC line transmits control signals. A control signal from the DDC line is input to an HDMI control section (not shown) and analyzed therein. An EDID ROM 2012 having unique information specifying the apparatus type of the relay apparatus 20 transmits the data of the unique information to the transmitting apparatus 10 through the DDC line.

Further, a Consumer Electronics Control (CEC) transmitting section 1062 performs interactive communications with a CEC processing section 2013 through a CEC line to transmit and receive control signals and control protocols of various apparatuses connected under HDMI standards.

As described above, the HDMI transmitting section 106 can transmit downmix coefficient information together with sound data and image data, by expanding the HDMI packets.

Further, the HDMI transmitting section 106 can transmit downmix coefficient information through the CEC line apart from transmission of sound data and image data, by expanding the CEC packets.

Furthermore, the HDMI transmitting section 106 can transmit downmix coefficient information by HDMI packets together with sound data and image data, by using a blanking interval of image data.

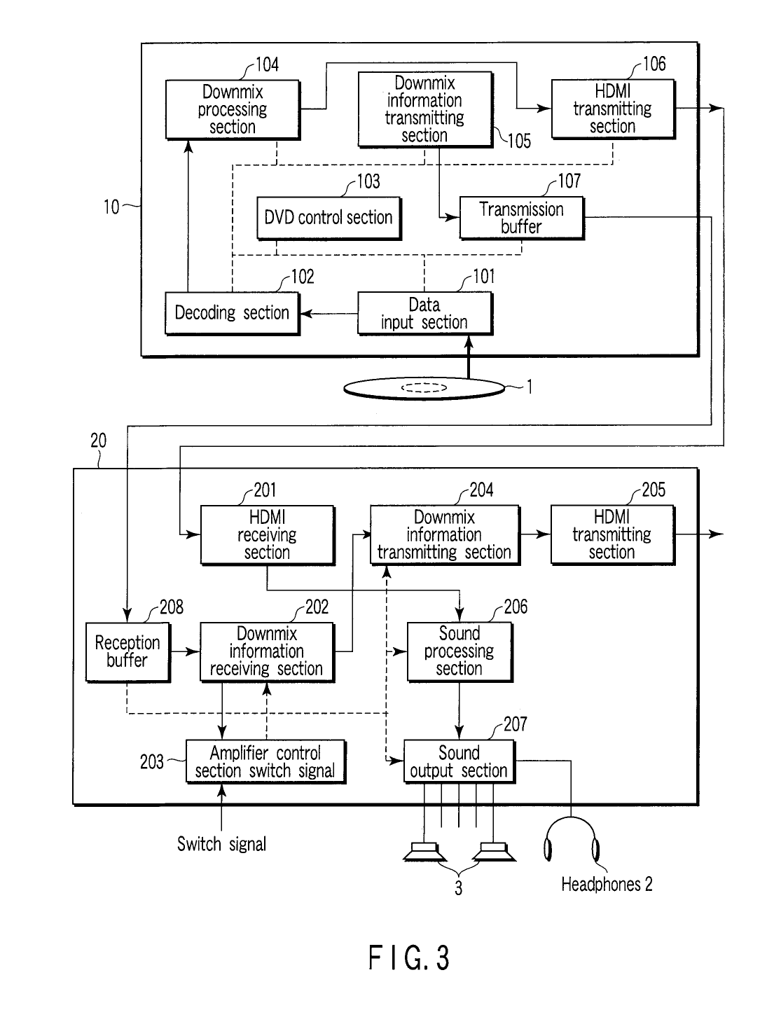

FIG. 3 illustrates another embodiment of the invention. As illustrated in FIG. 3, a downmix information transmitting section 105 of a transmitting apparatus 10 converts downmix coefficient information to HDMI packets, and thereafter transmits the HDMI packets to a reception buffer 208 of a relay apparatus 20 through a transmission buffer 107 controlled by a DVD control section 103. Although it is explained in this embodiment that the downmix coefficient information is converted into HDMI packets, the invention is not limited to this format. A signal line other than the HDMI signal line may be provided, and thereby load of information communication on the HDMI is reduced.

The relay apparatus 20 can be effectively used as an audio amplifier, since it has the HDMI transmitting and receiving sections and has a function of transmitting and receiving downmix information. Therefore, the relay apparatus 20 does not only serve as a terminal apparatus, but a next receiver 30 can be further connected to the relay apparatus 20.

The invention is not limited to the above embodiments, but software for processing downmix coefficient information may be additionally provided in the amplifier control section 203 and the TV control section 303.

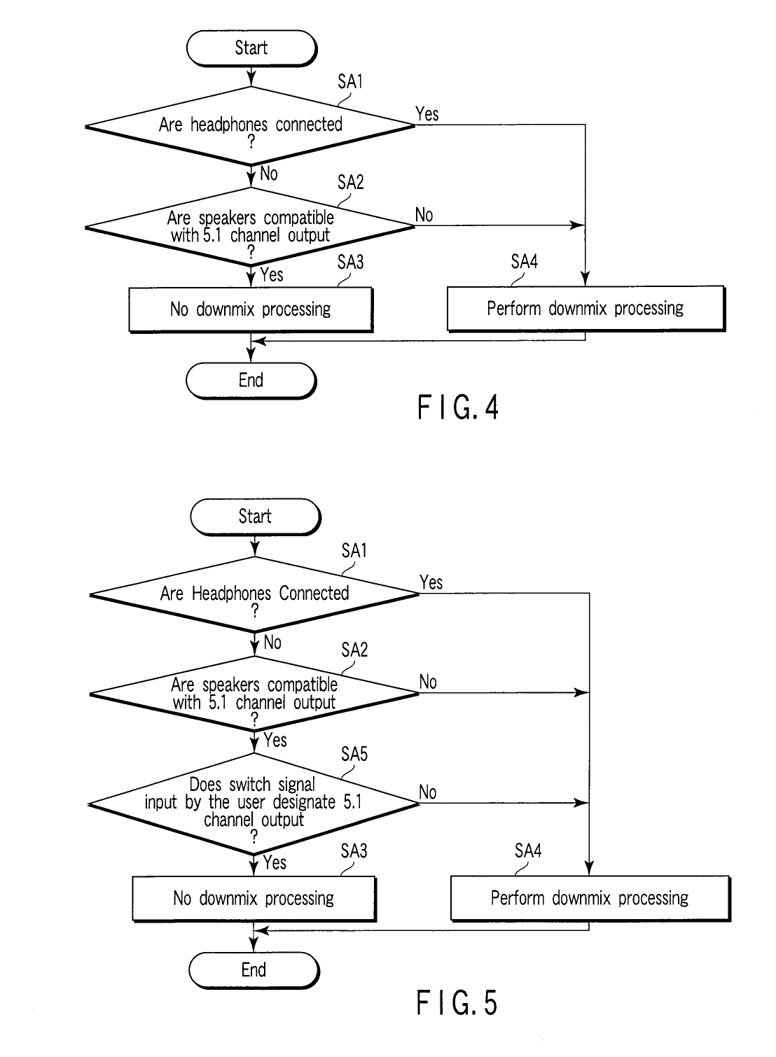

FIG. 4 illustrates an example of operation in the relay apparatus 20. First, it is determined whether headphones are connected or not (Step SA1). If no headphones are connected, it is checked whether the speaker connection state is a state compatible with 5.1 channel output (Step SA2). If the speaker connection state is a 5.1 channel connection state, sound outputs of the respective channels are obtained without performing downmix processing.

If it is determined in Step SA1 that headphones are connected and it is determined in Step SA2 that the speaker connection state is a 2 channels connection state, sound outputs are obtained by performing downmix processing (Step SA4).

FIG. 5 is a flowchart of operation in which a step of checking a switch signal input can be performed by user operation. In comparison with the flowchart of FIG. 4, the flowchart of FIG. 5 has Step SA5 between Steps SA2 and SA3. In Step SA5, the content of the switch signal is determined. If the switch signal designates 5.1 channel output, the apparatus goes to Step SA3, and downmix processing is not performed. If the switch signal designates 2 channels output, the apparatus goes to Step SA4, and performs downmix processing.

What is claimed is:

1. A sound playback apparatus comprising:
receiving means for obtaining a sound packet including sound data about outputs of a predetermined number of channels;
downmix information receiving means for obtaining downmix coefficient information;
control means for determining whether downmix processing is to be performed for the sound packet by using the downmix coefficient information or not;
sound processing means for performing downmix processing of the sound packet based on the downmix coefficient information, when the control means determines to perform downmix processing for the sound packet; and
sound output means for outputting the sound data downmixed by the sound processing means to speakers.

2. A sound playback apparatus according to claim 1, further comprising:
downmix information transmitting means for transmitting the downmix coefficient information to the outside.

3. A sound playback apparatus according to claim 1, wherein
the control means determines not to perform downmix processing when number of channels of the speakers connected to the sound output means is the same as the predetermined number of channels of the sound data included in the sound packet, and determines to perform downmix processing when the number of channels of the speakers connected to the sound output means is smaller than the predetermined number of channels of the sound data included in the sound packet.

4. A sound playback apparatus according to claim 2, wherein
the receiving means receives an HDMI packet and an HDMI expanded packet from an external apparatus connected by an HDMI through an HDMI cable,
the sound processing means processes the sound packet including the sound data about outputs of the predetermined number of channels transmitted with the HDMI packet, and
the downmix information receiving means obtains the downmix coefficient information from the HDMI expanded packet.

5. A sound playback apparatus according to claim 2, wherein
the receiving means receives an HDMI packet and an HDMI expanded packet from an external apparatus connected by an HDMI through an HDMI cable;
the sound processing section processes the sound packet including the sound data about outputs of the predetermined number of channels transmitted with the HDMI packet; and
the downmix information receiving means obtains the downmix coefficient information transmitted through a CEC line.

6. A sound playback apparatus according to claim 2, wherein
the receiving means receives an HDMI packet from an external apparatus connected by an HDMI through an HDMI cable;
the sound processing section processes the sound packet including the sound data about outputs of the predetermined number of channels transmitted with the HDMI packet; and
the downmix information receiving means obtains the downmix coefficient information superposed on a blanking interval of the image data transmitted with the HDMI packet.

7. A sound playback apparatus according to claim 2, wherein
the receiving means receives an HDMI packet from an external apparatus connected by an HDMI through an HDMI cable;
the sound processing section processes the sound packet including the sound data about outputs of the predetermined number of channels transmitted with the HDMI packet; and
the downmix information receiving means obtains the downmix coefficient information transmitted through a control signal line which is different from an HDMI line.

8. A sound playback method of processing sound data by using receiving means, sound processing means, sound output means, and control means, comprising:
obtaining a sound packet including sound data about outputs of a predetermined number of channels by the receiving means;
obtaining downmix coefficient information by downmix information receiving means;
determining by the control means whether downmix processing is to be performed for the sound packet by using the downmix coefficient information or not;
performing downmix processing of the sound packet by the sound processing means based on the downmix coefficient information, when the control means determines to perform downmix processing for the sound packet; and
outputting the downmixed sound data to speakers by the sound output means.

9. A sound playback method according to claim 8, comprising:
determining not to perform downmix processing when number of channels of the speakers is the same as the predetermined number of channels of the sound packet, and determining to perform downmix processing when the number of channels of the speakers is smaller than the predetermined number of channels of the sound packet.

10. A sound playback method according to claim 8, comprising:
receiving an HDMI packet an HDMI expanded packet by the receiving means from an external apparatus connected by an HDMI through an HDMI cable;
processing the sound packet including the sound data about outputs of the predetermined number of channels transmitted with the HDMI packet, by the sound processing means; and
obtaining the downmix coefficient information by the downmix information receiving means from the HDMI expanded packet, a CEC line, or a control signal line different from the HDMI.

11. A sound playback method according to claim 8, wherein the downmix coefficient information is transmitted to the outside by controlling downmix information transmitting means.
